(19) United States
(12) Patent Application Publication
(10) Pub. No.: US 2018/0116129 A1
(43) Pub. Date: May 3, 2018

(54) Tray Structure for Constructing Plant Tower

(71) Applicants: Sheng-Yu Tsai, Tainan City (TW); Han-Xi Cai, Tainan City (TW)

(72) Inventors: Sheng-Yu Tsai, Tainan City (TW); Han-Xi Cai, Tainan City (TW)

(21) Appl. No.: 15/335,471

(22) Filed: Oct. 27, 2016

(51) Int. Cl. A01G 9/12; B65D 21/02; A01G 9/10; H04R 1/02; F21V 23/00; F21V 33/00

(52) U.S. Cl. CPC A01G 9/12; B65D 21/0235; A01G 9/1073; F21Y 2115/10; F21V 23/002; F21V 33/0028; H04R 1/028

(57) ABSTRACT

A tray structure includes a plurality of trays stacking together from top to bottom and expanding in an alternating manner to construct a spiral plant tower. Each of the trays includes a bottom plate, a peripheral wall and a cultivating space. Each of the trays includes an inner tube provided with a protruding locking member, and an outer tube provided with a plurality of recessed locking members. The recessed locking members of the outer tube of an upper one of the trays are locked onto the protruding locking member of the inner tube of a lower one of the trays. Each of the trays includes a connecting tube located in and connected with the inner tube by a plurality of separating ribs. The connecting tubes of the trays are juxtaposed to each other when the trays are combined together.

### BACKGROUND OF THE INVENTION

### 1. Field of the Invention

The present invention relates to a tray structure and, more particularly, to a tray structure for constructing a plant tower.

### 2. Description of the Related Art

A conventional plant wall structure comprises an upright wall and a plurality of baskets suspended on the upright wall for receiving plants (or vegetables) and soils. Thus, the plants present an outstanding appearance to enhance the aesthetic quality of the conventional plant wall. However, the baskets lacks variation of shapes and angles, thereby limiting the versatility of the conventional plant wall.

### BRIEF SUMMARY OF THE INVENTION

In accordance with the present invention, there is provided a tray structure comprising a plurality of trays stacking together from top to bottom and expanding in an alternating manner to construct a spiral column-shaped plant tower. Each of the trays includes a bottom plate and a peripheral wall surrounding the bottom plate, with a cultivating space being defined between the bottom plate and the peripheral wall. Each of the trays includes an inner tube located at a first side of the bottom plate and provided with a protruding locking member, and an outer tube located at a second side of the bottom plate and provided with a plurality of recessed locking members. The recessed locking members of the outer tube of an upper one of the trays are locked onto the protruding locking member of the inner tube of a lower one of the trays. Each of the trays includes a connecting tube located in the inner tube and the outer tube and connected with the inner tube by a plurality of separating ribs. The connecting tubes of the trays are juxtaposed to each other when the trays are combined together.

According to the primary advantage of the present invention, the trays are stacked from top to bottom and are expanded in an alternating manner to construct a spiral column-shaped plant tower, so that the tray structure has a three-dimensional outstanding outer appearance with a shape variation.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a tray structure in accordance with a first preferred embodiment of the present invention.

FIG. 2 is a perspective view of a tray structure in accordance with a second preferred embodiment of the present invention.

FIG. 3 is an exploded perspective view of the tray structure in accordance with the first and second preferred embodiments of the present invention.

FIG. 4 is an exploded perspective view of one of the trays of the tray structure in accordance with the first preferred embodiment of the present invention.

FIG. 5 is a top view of the tray structure as shown in FIG. 1.

FIG. 6 is a front cross-sectional view of the tray structure as shown in FIG. 1.

FIG. 7 is a cross-sectional view of the tray structure taken along line Y-Y as shown in FIG. 6.

FIG. 8 is a cross-sectional view of the tray structure taken along line D-D as shown in FIG. 6.

FIG. 9 is a front cross-sectional view of the tray structure as shown in FIG. 2.

FIG. 10 is a perspective operational view showing the tray structure being disposed at an illuminating state.

FIG. 11 is a cross-sectional operational view showing the tray structure being disposed at a cultivating and music playing state.

FIG. 12 is a cross-sectional operational view showing the tray structure being disposed at a cultivating, music playing, illuminating and atomizing state.

FIG. 13 is a perspective view showing the dividing net dividing each of the trays into a cultivating zone and an atomized zone.

### DETAILED DESCRIPTION OF THE INVENTION

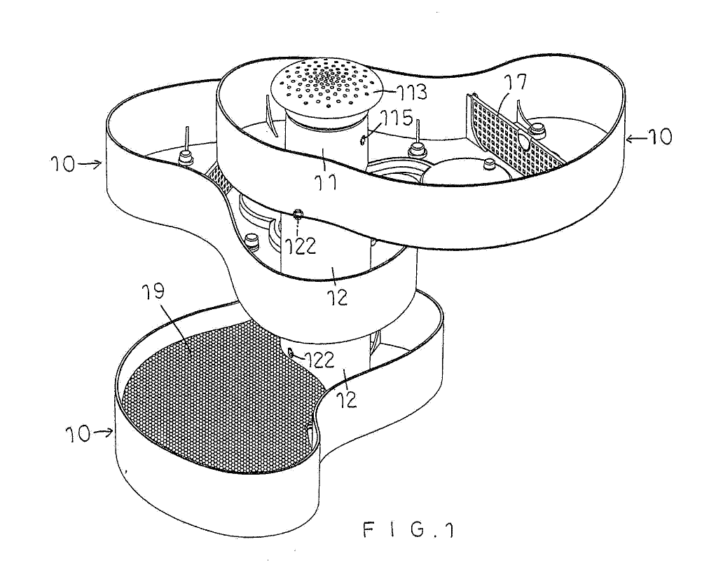

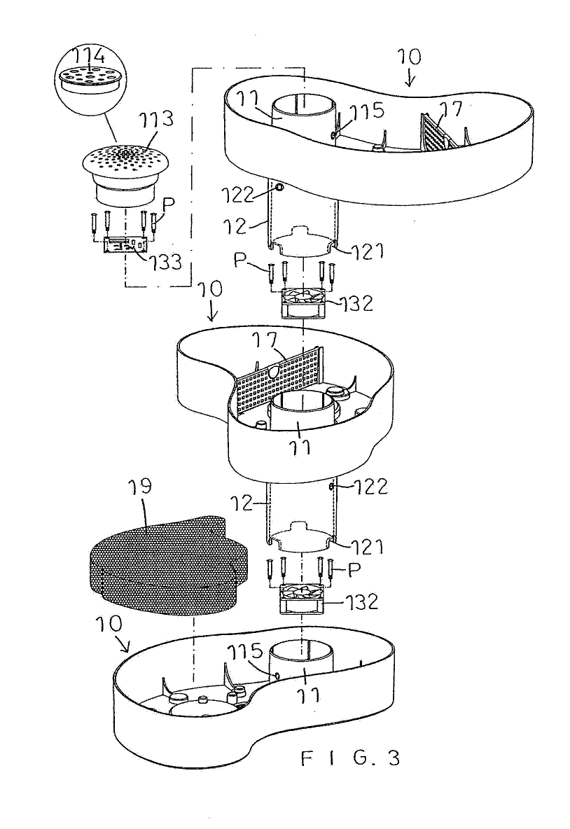

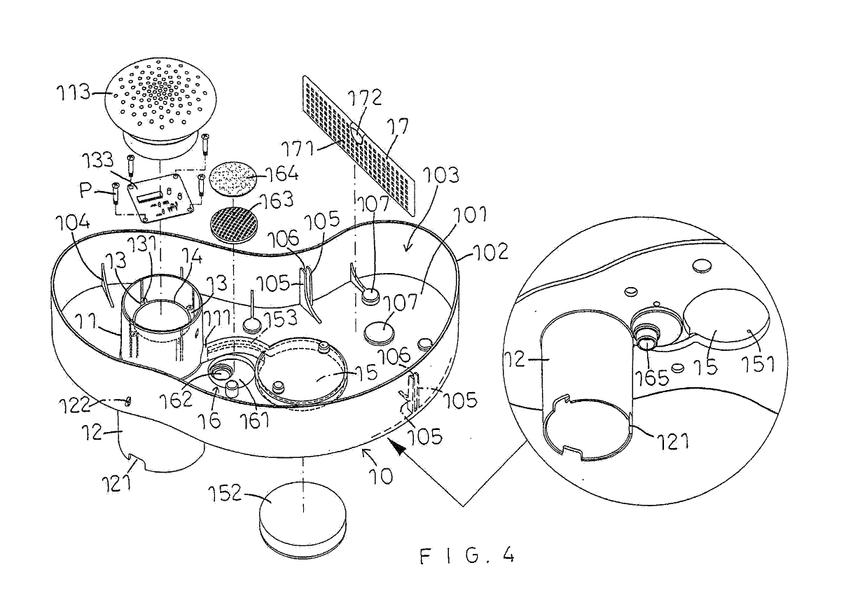

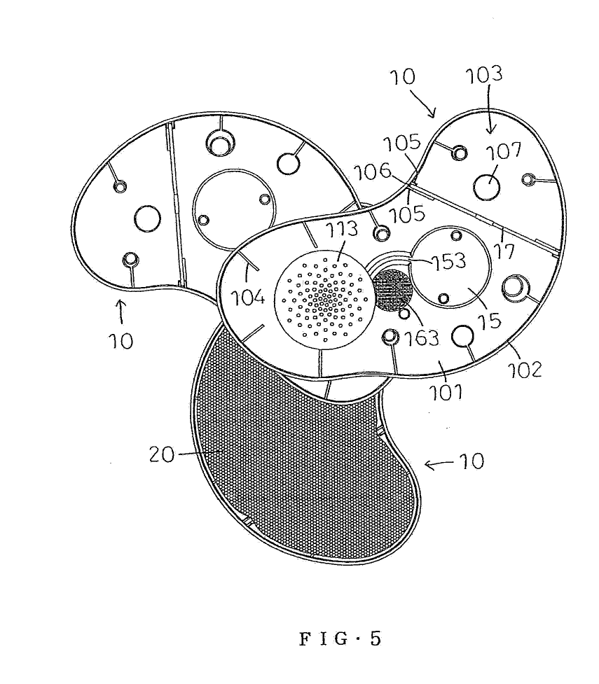

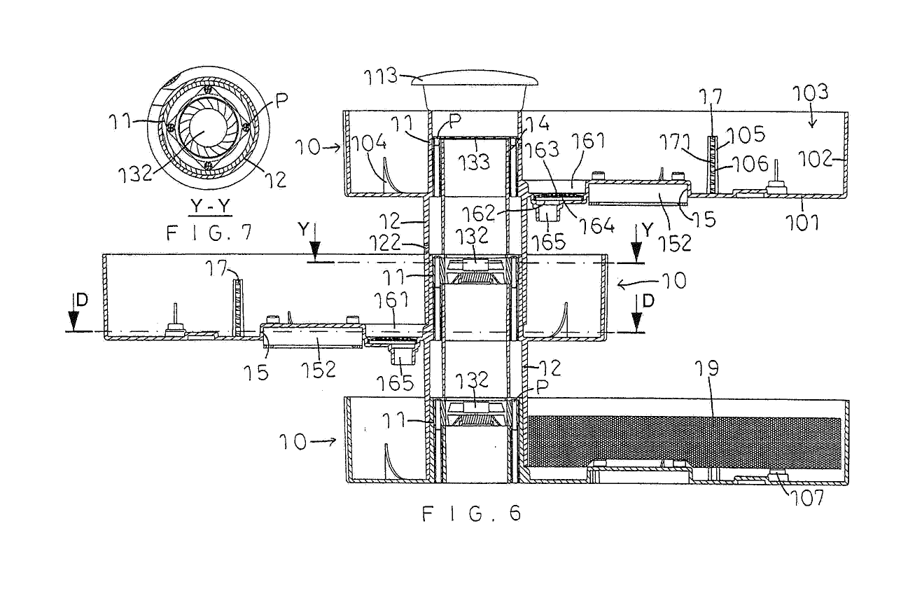

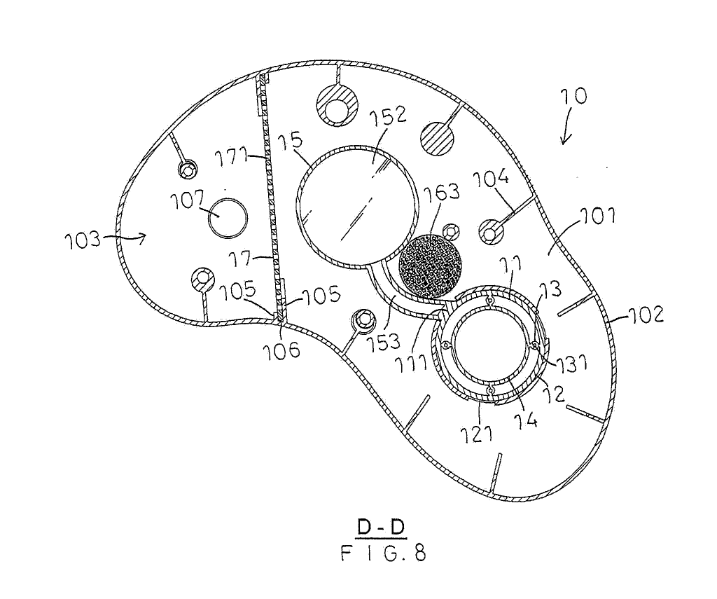

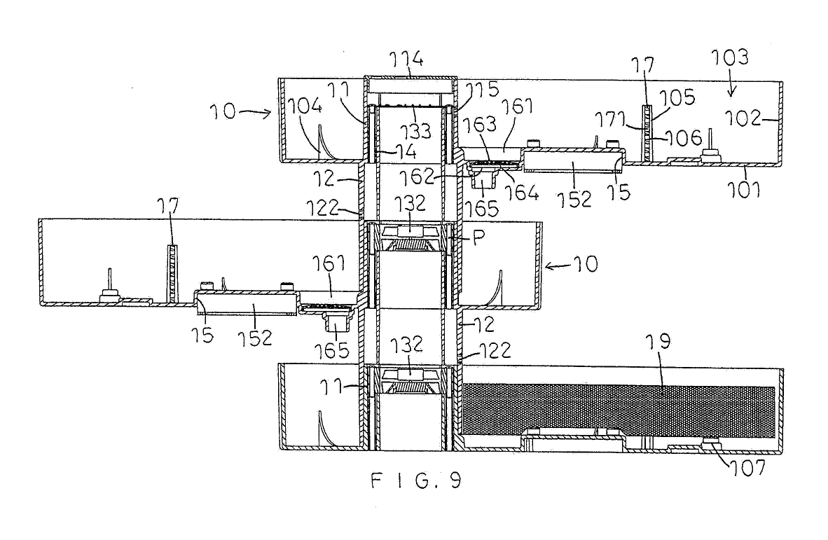

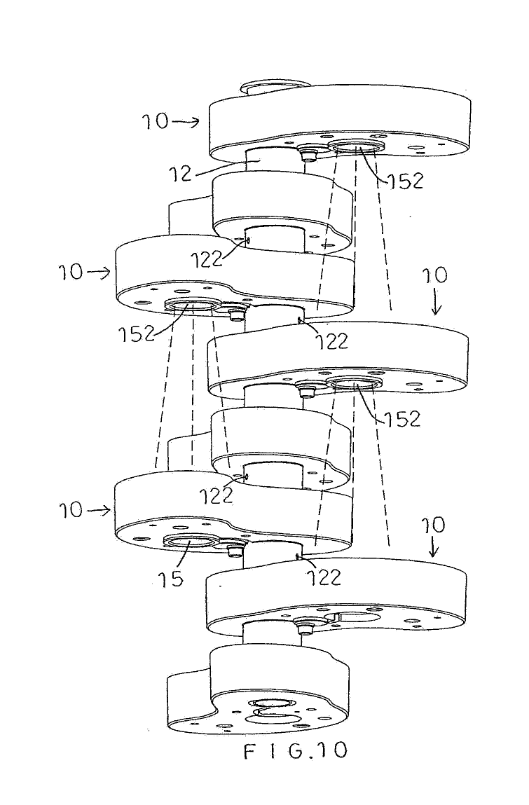

Referring to the drawings and initially to FIGS. 1-10, a tray structure in accordance with the preferred embodiment of the present invention comprises a plurality of trays 10 stacking together from top to bottom and expanding in an alternating manner to construct a spiral column-shaped plant tower.

Each of the trays 10 includes a bottom plate 101 and a peripheral wall 102 surrounding the bottom plate 101, with a cultivating space 103 being defined between the bottom plate 101 and the peripheral wall 102. The cultivating space 103 of each of the trays 10 is used to cultivate plants by water. Each of the trays 10 includes an inner tube 11 located at a first side of the bottom plate 101 and provided with a protruding locking member 111, and an outer tube 12 located at a second side of the bottom plate 101 and provided with a plurality of recessed locking members 121. The inner tube 11 of each of the trays 10 is received in the cultivating space 103 and surrounded by the peripheral wall 102. The outer tube 12 of each of the trays 10 protrudes outward from the bottom plate 101. In assembly, the recessed locking members 121 of the outer tube 12 of an upper one of the trays 10 are locked onto the protruding locking member 111 of the inner tube 11 of a lower one of the trays 10, so that the trays 10 are integrally combined together. Each of the trays 10 includes a connecting tube 14 located in the inner tube 11 and the outer tube 12 and connected with the inner tube 11 by a plurality of separating ribs 13. The connecting tubes 14 of the trays 10 are juxtaposed to each other when the trays 10 are combined together to provide a structural reinforcement.

In the preferred embodiment of the present invention, each of the trays 10 includes a plurality of substantially L-shaped reinforcing ribs 104 located in the cultivating space 103 and connected with the bottom plate 101 and the peripheral wall 102. The reinforcing ribs 104 reinforce the structural strength of each of the trays 10.

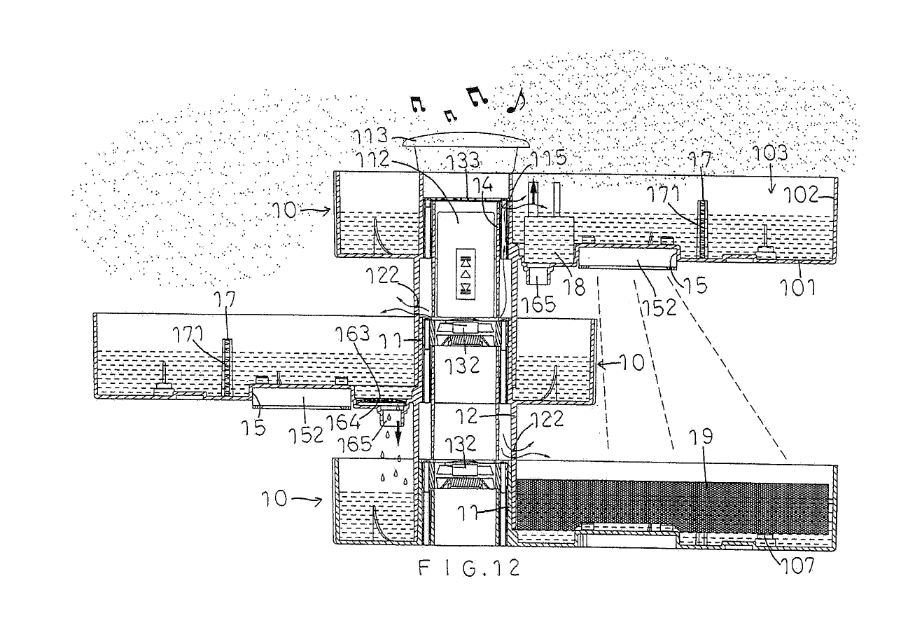

In the preferred embodiment of the present invention, the uppermost one of the trays 10 includes a music player 112 (see FIGS. 11 and 12) mounted in the inner tube 11, and a waterproof speaker 113 mounted on the inner tube 11 and electrically connected with the music player 112 so that music of the music player 112 is transmitted and played by the waterproof speaker 113.

In the preferred embodiment of the present invention, each of the trays 10 includes a lamp holder 15 mounted on the second side of the bottom plate 101 and provided with two fixing holes 151, a light emitting diode (LED) lamp 152 mounted on the lamp holder 15 by the fixing holes 151 of the lamp holder 15, and a channel 153 formed in the bottom plate 101 and connected between the lamp holder 15 and the outer tube 12 to allow an electric wire of the LED lamp 152 to extend through the channel 153 into the outer tube 12. Thus, the LED lamp 152 emits light downward to provide a light source to a plant (see FIGS. 11 and 12).

In the preferred embodiment of the present invention, each of the trays 10 includes a mounting portion 16 formed on the bottom plate 101 and located between the lamp holder 15 and the inner tube 11, a filtering net 163 mounted in the mounting portion 16, and a non-woven fabric 164 mounted in the mounting portion 16. The filtering net 163 and the non-woven fabric 164 are used for filtering impurities contained in the water. The mounting portion 16 of each of the trays 10 is connected to the cultivating space 103 and includes a receiving depression 161 for mounting the filtering net 163 and the non-woven fabric 164, a water outlet 162 located under the receiving depression 161, and a water drain head 165 extending downward from the water outlet 162 to introduce excessive water in the cultivating space 103 into a lower one of the trays 10 (see FIGS. 11 and 12).

In the preferred embodiment of the present invention, each of the trays 10 includes two opposite mounting brackets 105 mounted in the cultivating space 103, and a dividing net 17 mounted between the two mounting brackets 105. Each of the two mounting brackets 105 is connected with the bottom plate 101 and the peripheral wall 102 and is provided with a slot 106 to allow insertion of the dividing net 17. The dividing net 17 of each of the trays 10 is provided with a plurality of net holes 171. The dividing net 17 of each of the trays 10 has a top provided with an arcuate finger hole 172 to facilitate the user gripping the dividing net 17.

In the preferred embodiment of the present invention, each of the trays 10 includes a plurality of reinforcing projections 107 mounted on the bottom plate 101 and located in the cultivating space 103, and a water absorbing sponge 19 placed in the cultivating space 103.

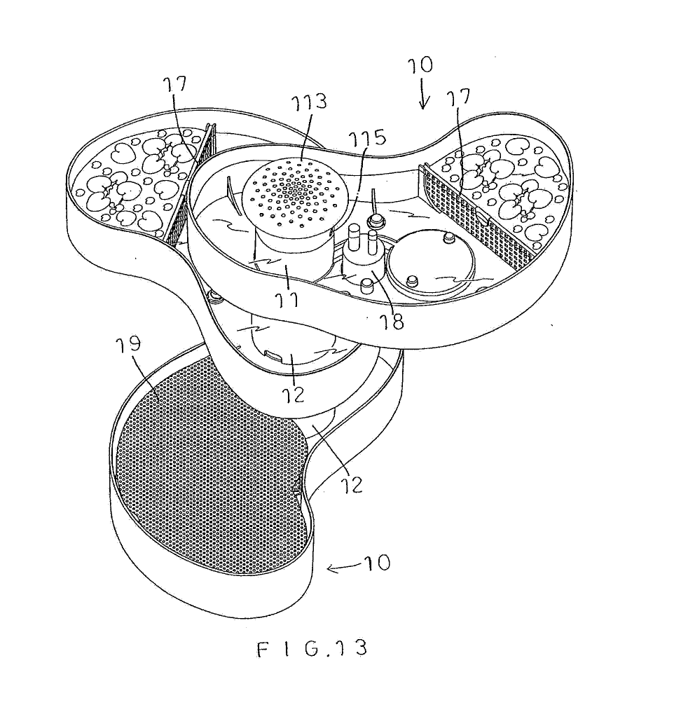

In the preferred embodiment of the present invention, the uppermost one of the trays 10 includes an atomizer 18 (see FIGS. 12 and 13) mounted in the receiving depression 161 of the mounting portion 16. At the same time, the dividing net 17 divides each of the trays 10 into a cultivating zone and an atomized zone so as to separate the floating plant from the atomizer 18.

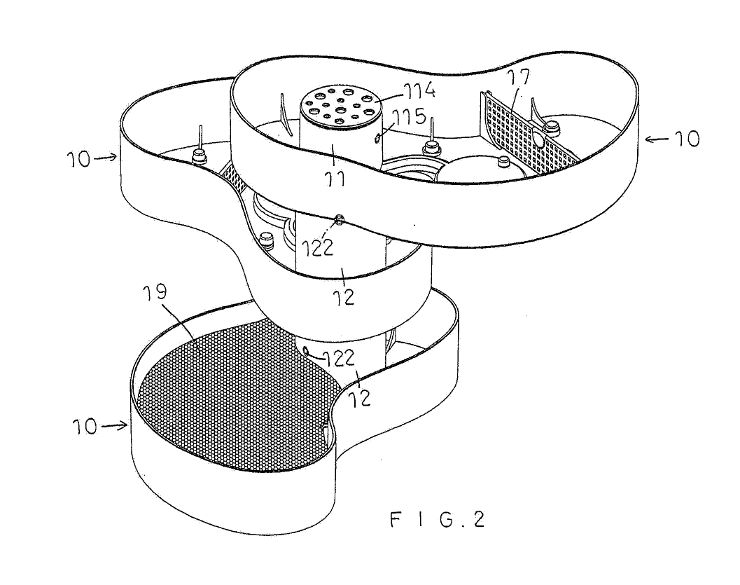

In the preferred embodiment of the present invention, the uppermost one of the trays 10 includes a ventilating cover 114 (see FIGS. 2, 3 and 9) mounted on the inner tube 11 to replace the music player 112 and the waterproof speaker 113. Each of the trays 10 includes a first air hole 115 formed in the inner tube 11, and a second air hole 122 formed in the outer tube 12. Each of the separating ribs 13 of each of the trays 10 has an upper end provided with a fixing point 131. Preferably, each of the trays 10 includes a fan 132 mounted on the fixing points 131 of the separating ribs 13 by a plurality of screws “P”. The fan 132 introduces air to the second air hole 122. Alternatively, one of the trays 10 includes a circuit board 133 mounted on the fixing points 131 of the separating ribs 13 by a plurality of screws “P”. The circuit board 133 provides bluetooth functions.

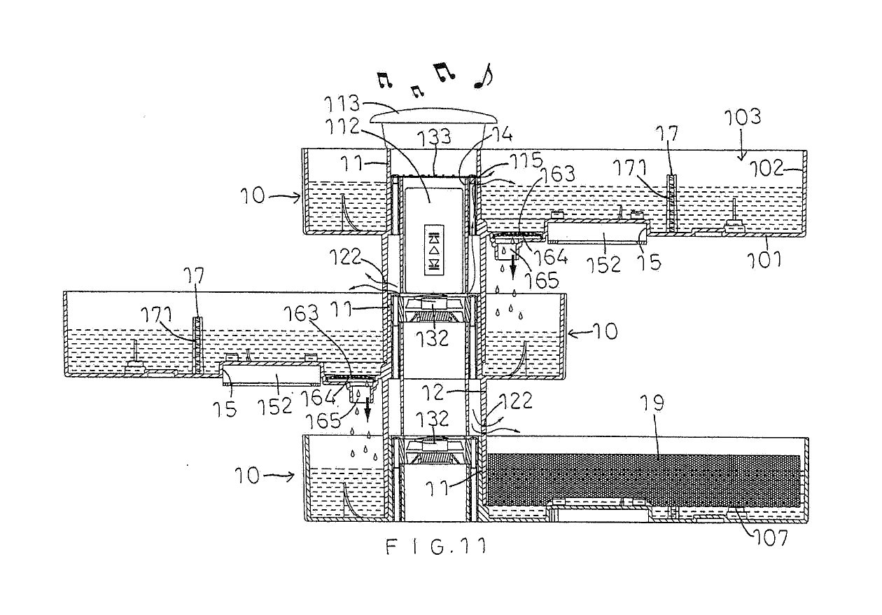

As shown in FIG. 10, the tray structure is disposed at an illuminating state. At this time, the LED lamp 152 of each of the trays 10 emits light downward to provide a lighting function to the plants to be cultivated.

As shown in FIG. 11, the tray structure is disposed at a cultivating and music playing state. At this time, the cultivating space 103 of each of the trays 10 is used to cultivate plants by water. In addition, the water drain head 165 of each of the trays 10 is used to introduce excessive water in the cultivating space 103 into a lower one of the trays 10. At the same time, the music of the music player 112 is transmitted and played by the waterproof speaker 113.

As shown in FIG. 12, the tray structure is disposed at a cultivating, music playing, illuminating and atomizing state. At this time, the cultivating space 103 of each of the trays 10 is used to cultivate plants by water. In addition, the water drain head 165 of each of the trays 10 is used to introduce excessive water in the cultivating space 103 into a lower one of the trays 10. At the same time, the music of the music player 112 is transmitted and played by the waterproof speaker 113. At the same time, the LED lamp 152 of each of the trays 10 emits light downward to provide a lighting function to the plants to be cultivated. At the same time, the atomizer 18 provides an atomized function.

As shown in FIG. 13, the dividing net 17 divides each of the trays 10 into a cultivating zone and an atomized zone so as to separate the floating plants from the atomizer 18.

Accordingly, the trays 10 are stacked from top to bottom and are expanded in an alternating manner to construct a spiral column-shaped plant tower, so that the tray structure has a three-dimensional outstanding outer appearance with a shape variation. In addition, the angles between the trays 10 can be changed to enhance the aesthetic quality of the tray structure. Further, the trays 10 are spaced from each other to provide a better ventilating space for cultivating the plants. Further, the trays 10 provide a lighting function to the plants to promote growth of the plants.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A tray structure comprising:
a plurality of trays stacking together from top to bottom and expanding in an alternating manner to construct a spiral column-shaped plant tower;
wherein:
each of the trays includes a bottom plate and a peripheral wall surrounding the bottom plate, with a cultivating space being defined between the bottom plate and the peripheral wall;
each of the trays includes an inner tube located at a first side of the bottom plate and provided with a protruding locking member, and an outer tube located at a second side of the bottom plate and provided with a plurality of recessed locking members;
the recessed locking members of the outer tube of an upper one of the trays are locked onto the protruding locking member of the inner tube of a lower one of the trays;
each of the trays includes a connecting tube located in the inner tube and the outer tube and connected with the inner tube by a plurality of separating ribs; and
the connecting tubes of the trays are juxtaposed to each other when the trays are combined together.

2. The tray structure of claim 1, wherein each of the trays includes a plurality of reinforcing ribs located in the cultivating space and connected with the bottom plate and the peripheral wall.

3. The tray structure of claim 1, wherein the uppermost one of the trays includes a music player mounted in the inner tube, and a waterproof speaker mounted on the inner tube and electrically connected with the music player.

4. The tray structure of claim 1, wherein each of the trays includes a lamp holder mounted on the second side of the bottom plate and provided with two fixing holes, a light emitting diode (LED) lamp mounted on the lamp holder by the fixing holes of the lamp holder, and a channel formed in the bottom plate and connected between the lamp holder and the outer tube to allow an electric wire of the LED lamp to extend through the channel into the outer tube.

5. The tray structure of claim 1, wherein:
each of the trays includes a mounting portion formed on the bottom plate, a filtering net mounted in the mounting portion, and a non-woven fabric mounted in the mounting portion; and
the mounting portion of each of the trays includes a receiving depression for mounting the filtering net and the non-woven fabric, a water outlet located under the receiving depression, and a water drain head extending downward from the water outlet.

6. The tray structure of claim 1, wherein:
each of the trays includes two opposite mounting brackets mounted in the cultivating space, and a dividing net mounted between the two mounting brackets;
each of the two mounting brackets is connected with the bottom plate and the peripheral wall and is provided with a slot to allow insertion of the dividing net;
the dividing net of each of the trays is provided with a plurality of net holes; and
the dividing net of each of the trays has a top provided with an arcuate finger hole.

7. The tray structure of claim 1, wherein each of the trays includes a plurality of reinforcing projections mounted on the bottom plate and located in the cultivating space, and a water absorbing sponge placed in the cultivating space.

8. The tray structure of claim 5, wherein the uppermost one of the trays includes an atomizer mounted in the receiving depression of the mounting portion.

9. The tray structure of claim 1, wherein:
the uppermost one of the trays includes a ventilating cover mounted on the inner tube;
each of the trays includes a first air hole formed in the inner tube, and a second air hole formed in the outer tube;
each of the separating ribs of each of the trays has an upper end provided with a fixing point;
each of the trays includes a fan mounted on the fixing points of the separating ribs by a plurality of screws; and
the fan introduces air to the second air hole.

10. The tray structure of claim 9, wherein:
one of the trays includes a circuit board mounted on the fixing points of the separating ribs by a plurality of screws; and
the circuit board provides bluetooth functions.
